(19) United States
(12) Patent Application Publication
(10) Pub. No.: US 2017/0127141 A1
(43) Pub. Date: May 4, 2017

(54) METHOD AND ELECTRONIC DEVICE FOR DYNAMIC REMINDING OF LIVE BROADCAST CONTENTS

(71) Applicants: Le Holdings (Beijing) Co., Ltd., Beijing (CN); Lemobile Information Technology (Beijing) Co., ltd., Beijing (CN)

(72) Inventor: Junkai YIN, Beijing (CN)

(21) Appl. No.: 15/246,525

(22) Filed: Aug. 24, 2016

Related U.S. Application Data
(63) Continuation of application No. PCT/CN2016/086083, filed on Jun. 16, 2016.

(30) Foreign Application Priority Data
Oct. 30, 2015 (CN) 2015107329692

(51) Int. Cl. H04N 21/488; H04N 21/431; H04N 21/2187; H04N 21/414

(52) U.S. Cl. CPC H04N 21/4882; H04N 21/41407; H04N 21/4312; H04N 21/2187

(57) ABSTRACT

Disclosed are a method and electronic device for dynamic reminding of live broadcast contents, wherein the method includes: acquiring live broadcast appointment information submitted by a user, the live broadcast appointment information comprising live broadcast content information and/or appointment time information; determining an appointment time point according to the live broadcast appointment information, the appointment time point being a time point when the live broadcast content appointed by the user begins to play; and when the current time point reaches the appointment time point, pushing a live broadcast message to the user, and switching a live broadcast icon from a stationary state to a dynamic reminding state. According to the method, the live broadcast icon is dynamically changed to remind the user of the presence of a currently live-broadcasted content, without affecting the appearance of the live broadcast icon.

### CROSS REFERENCE TO RELATED APPLICATIONS

This application is a continuation of International Application No. PCT/CN2016/086083, filed on Jun. 16, 2016, which is based upon and claims priority to Chinese Patent Application No. 2015107329692, filed on Oct. 30, 2015, the entire contents of which are incorporated herein by reference.

### TECHNICAL FIELD

The disclosure relates to the technical field of communication, and more particularly to a method and electronic device for dynamic reminding of live broadcast contents.

### BACKGROUND

With the development of smart phones, they have been applied all over the world. A smart phone has an excellent operating system, can be installed with all kinds of application software freely, and has a sense of full-touch-screen type operation of a full large screen. The existing application software can push notification messages to users, and display a red number representing the number of notification messages in the upper-right corner. For an application capable of live broadcasting, the user can make an appointment for a number of future programs through the application, and the application notifies the user of a currently live-broadcasted content when the programs begin.

During the implementation of the present invention, the inventor has discovered at least the following problems in the prior art:

The existing way of pushing a notification using the red number in the upper-right corner is relatively stiff and also poor in user experience. As the overall aesthetic property of the desktop is affected by the red number, part of users will coercively eliminate it, thereby increasing the operation steps of the users; and meanwhile, since all the applications adopt this notification way, the notification of a live broadcast video is easy to be ignored by a user when the live broadcast video appointed by the user is being played.

### SUMMARY

In order to overcome the defect in the prior art that a reminder in an application reminding a user of the presence of a live-broadcasted video content is easy to be ignored by the user, the present invention, according to one aspect of the present invention, provides a method for dynamic reminding of live broadcast contents.

A method for dynamic reminding of live broadcast contents, provided in the embodiment of the present invention includes acquiring live broadcast appointment information submitted by a user, the live broadcast appointment information comprising live broadcast content information and/or appointment time information determining an appointment time point according to the live broadcast appointment information, the appointment time point being a time point when the live broadcast content appointed by the user begins to play; and pushing, when the current time point reaches the appointment time point, a live broadcast message to the user, and switching a live broadcast icon from a stationary state to a dynamic reminding state.

Based on the same inventive concept, the disclosure also provides an electronic device, comprising:
at least one processor; and
a memory communicably connected with the at least one processor for storing instructions executable by the at least one processor, wherein execution of the instructions by the at least one processor causes the at least one processor to:
acquiring live broadcast appointment information submitted by a user, the live broadcast appointment information comprising live broadcast content information and/or appointment time information;
determining an appointment time point according to the live broadcast appointment information, the appointment time point being a time point when the live broadcast content appointed by the user begins to play; and
pushing, when the current time point reaches the appointment time point, a live broadcast message to the user, and switching a live broadcast icon from a stationary state to a dynamic reminding state.

Based on the same inventive concept, the disclosure further provides an A non-transitory computer-readable storage medium storing executable instructions that, when executed by an electronic device, cause the electronic device to:
acquiring live broadcast appointment information submitted by a user, the live broadcast appointment information comprising live broadcast content information and/or appointment time information;
determining an appointment time point according to the live broadcast appointment information, the appointment time point being a time point when the live broadcast content appointed by the user begins to play; and
pushing, when the current time point reaches the appointment time point, a live broadcast message to the user, and switching a live broadcast icon from a stationary state to a dynamic reminding state.

According to the method and electronic device for dynamic reminding of live broadcast contents provided in the embodiment of the present invention, an appointment time point is determined according to live broadcast appointment information submitted by a user, and a live broadcast icon is switched to a dynamic reminding state at the appointment time point. The method does not need to mark a red number in the right-upper corner of the icon, and the live broadcast icon is dynamically changed to remind the user of the presence of currently live-broadcasted contents, without affecting the appearance of the live broadcast icon. By setting a dynamic reminding identification or a dynamic reminding instruction, the icons of other applications can be displayed in a distinguishing way, and thus the dynamic reminding function of the live broadcast icon can be displayed in a more highlighted way. The live broadcast icon is additionally provided with a dynamically displayed icon, so that the number of live broadcast reminding can be differentiated.

Other features and advantages of the present invention will be illustrated in the description that follows, and partially become apparent from the description, or will be understood by implementation of the present invention. The object and other advantages of the present invention can be achieved and obtained through a structure specified in the written description, claims and accompanying drawings.

Hereinafter, the technical solution of the present invention will be further described in details through the accompanying drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of the method for dynamic reminding of live broadcast contents in the embodiment of the present invention;

FIG. 2 is a schematic diagram of dynamic display of the live broadcast icon in the embodiment of the present invention;

FIG. 3 is a schematic diagram of dynamic display of the lock screen interface in the embodiment of the present invention;

FIG. 4 is a flow diagram of the method for dynamic reminding of live broadcast contents in Embodiment 1;

FIG. 5 is a first structure diagram of the electronic device for dynamic reminding of live broadcast contents in the embodiment of the present invention;

FIG. 6 is a second structure diagram of the electronic device for dynamic reminding of live broadcast contents in the embodiment of the present invention;

FIG. 7 is a third structure diagram of the electronic device for dynamic reminding of live broadcast contents in the embodiment of the present invention;

FIG. 8 is a fourth structure diagram of the electronic device for dynamic reminding of live broadcast contents in the embodiment of the present invention;

FIG. 9 is a fifth structure diagram of the electronic device for dynamic reminding of live broadcast contents in the embodiment of the present invention.

### DETAILED DESCRIPTION

The specific embodiment of the present invention will be described below in details with reference to the accompanying drawings, but it should be appreciated that the protection scope of the present invention is not limited by the specific embodiment.

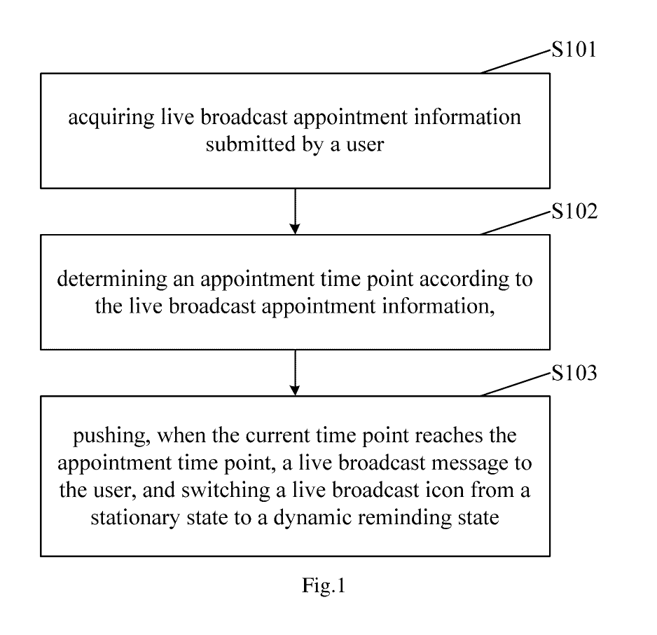

According to the embodiment of the present invention, a method for dynamic reminding of live broadcast contents is provided, FIG. 1 is a flow diagram of the method, and the method specifically comprises steps 101-103:

S101: acquiring live broadcast appointment information submitted by a user, the live broadcast appointment information comprising live broadcast content information and/or appointment time information.

In the embodiment of the present invention, the dynamic reminding method is applicable to live broadcast appointment operations. Specifically, a user submits live broadcast appointment information through a live broadcast application at first to make an appointment of a favorite live broadcast program; and the live broadcast appointment information includes live broadcast content information (for example, the live broadcast content may specifically be the Network News Broadcast of a certain day, or a certain variety show of a certain episode, etc.) and/or appointment time information. The appointment time information is information related to the appointment time directly input by the user, for example, the beginning time of a certain live broadcast content is 13:00, the user can input time information like 12:50 or 13:10, and the appointment time information can determine an appointment time point.

S102: determining an appointment time point according to the live broadcast appointment information, the appointment time point being a time point when the live broadcast content appointed by the user begins to play.

Specifically, the time point when a live broadcast content begins is taken as the appointment time point, or the appointment time in the appointment time information is taken as the appointment time point.

S103: pushing, when the current time point reaches the appointment time point, a live broadcast message to the user, and switching a live broadcast icon from a stationary state to a dynamic reminding state.

In the embodiment of the present invention, when the current time point reaches the appointment time point, a dynamic reminding operation is triggered, i.e. the live broadcast icon is switched from a stationary state to a dynamic reminding state. Specifically, the dynamic reminding state of the live broadcast icon includes:
rotating the live broadcast icon or part of images in the live broadcast icon along a preset direction; and/or
periodically changing the color of the live broadcast icon or part of images in the live broadcast icon; and/or
periodically changing the transparency of the live broadcast icon or part of images in the live broadcast icon; and/or
periodically zooming the size of the live broadcast icon or part of images in the live broadcast icon.

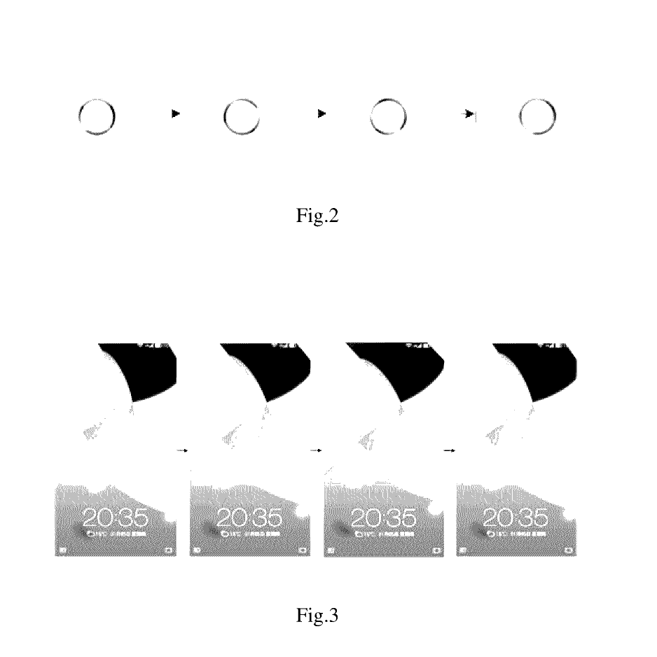

Specifically, the live broadcast icon can be rotated by taking the center of the icon as the center of a circle, or a circular image in the live broadcast icon can be rotated continuously; or, the color of the live broadcast icon can be periodically changed according to a preset color display order; or the size of the live broadcast icon is changed to periodically zoom the live broadcast icon. The above-mentioned various dynamic reminding states can also be combined together; for example, a certain live broadcast icon is a circular icon containing a circular ring therein, and after this live broadcast icon is switched to a dynamic reminding state, the circular ring is changed into a colored circular ring and is rotated continuously, specifically as shown in FIG. 2 which schematically shows dynamic rotation through four continuous images.

According to the method for dynamic reminding of live broadcast contents provided in the embodiment of the present invention, an appointment time point is determined according to the live broadcast appointment information submitted by a user, and a live broadcast icon is switched to a dynamic reminding state at the appointment time point. The method does not need to mark a red number in the right-upper corner of the icon, and the live broadcast icon is dynamically changed to remind the user of the presence of the currently live-broadcasted contents, without affecting the appearance of the live broadcast icon.

In one embodiment, when the current time point reaches the appointment time point, the method further includes:
judging whether the live broadcast icon has a dynamic reminding identification which is used for marking that the live broadcast icon has a dynamic reminding function; and when the live broadcast icon has the dynamic reminding identification, switching the live broadcast icon from a stationary state to a dynamic reminding state; or
judging whether the live broadcast appointment information contains a dynamic reminding instruction which is used for instructing the live broadcast icon to execute a dynamic reminding operation at the appointment time point; and when the live broadcast appointment information contains the dynamic reminding instruction, switching the live broadcast icon from a stationary state to a dynamic reminding state.

In the embodiment of the present invention, a dynamic reminding identification or a dynamic reminding instruction is set for screening those conditions under which the live broadcast icon cannot or does not need to be switched to a dynamic reminding state. Meanwhile, by setting the dynamic reminding identification or the dynamic reminding instruction, the icons of other applications can be displayed in a distinguishing way (that is to say, when the other applications have reminding messages, their icons are still displayed in a stationary state), and thus the dynamic reminding function of the live broadcast icon can be displayed in a more highlighted way.

In one embodiment, after the live broadcast icon is switched from a stationary state to a dynamic reminding state, the method further includes: switching, after receiving a live broadcast content playing instruction input by a user, the live broadcast icon to a stationary state.

In one embodiment, after the live broadcast icon is switched from a stationary state to a dynamic reminding state, the method further includes: dynamically displaying, when a mobile terminal is in a lock screen interface, the lock screen interface or part of images in the lock screen interface. Specifically, as shown in FIG. 3, the lock screen interface of the mobile terminal includes a windmill, which is set to be in a rotating state when dynamic reminding is needed. FIG. 3 schematically shows dynamic rotation through four continuous pictures.

In one embodiment, after the live broadcast icon is switched from a stationary state to a dynamic reminding state, if the appointment time points of other live broadcast programs exist, then the method further includes: when the live broadcast icon is in a dynamic reminding state and the current time point reaches another appointment time point again, additionally adding a dynamically displayed icon for the live broadcast icon.

The current time point in the embodiment of the present invention is a certain time point during operation of the method flow, and with the progression of the flow, the time point changes all the time. After the live broadcast icon is switched from a stationary state to a dynamic reminding state, a user does not operate the live broadcast icon all the time; and if the current time point reaches another appointment time point later (that is to say, there is reminding of at least two live broadcast contents at this moment), then a dynamically displayed icon is additionally added for the live broadcast icon to differentiate the number of live broadcast reminding.

Specifically, take the live broadcast icon shown in FIG. 2 as an example, the additionally added, dynamically displayed icon may be: a rotating concentric circle added for the live broadcast icon; or a circular ring covering the original circular ring with a higher rotating speed (equivalent to changing the rotating speed of the original circular ring); or a circular ring in a deeper color covering the original circular ring (equivalent to changing the color depth of the original circular ring), etc.

Hereinafter, the flow of the method will be introduced in details through an embodiment.

### Embodiment 1

In Embodiment 1, a dynamically rotating colored circular ring is used for representing that the live broadcast icon is in a dynamic reminding state, and specifically, the method includes steps 401-407:
S401: acquiring live broadcast appointment information submitted by a user, the live broadcast appointment information comprising live broadcast content information;
S402: determining the beginning time of the live broadcast content according to the live broadcast content information and an electronic program menu;
S403: taking the beginning time of the live broadcast content as an appointment time point of the live broadcast content;
S404: pushing, when the current time point reaches the appointment time point, a live broadcast message to the user;
S405: switching a stationary circular ring of the live broadcast icon to a colored circular ring, and rotating the circular ring at a first preset angular speed;
S406: when the live broadcast icon is in a dynamic reminding state and the current time point reaches another appointment time point again, switching the colored circular ring rotating at the first angular speed to be rotated at a second angular speed, wherein the second angular speed is greater than the first angular speed;
S407: switching, after receiving a live broadcast content playing instruction input by a user, the live broadcast icon to a stationary state.

Specifically, the user clicks or drags back the live broadcast icon; or a smart television is associated with an application related to the live broadcast icon, the user watches the live broadcast content through the smart television, etc., and the above ways can all be used as the operation of inputting the live broadcast content playing instruction by the user.

According to the method for dynamic reminding of live broadcast contents provided in the embodiment of the present invention, an appointment time point is determined according to live broadcast appointment information submitted by a user, and a live broadcast icon is switched to a dynamic reminding state at the appointment time point. The method does not need to mark a red number in the right-upper corner of the icon, and the live broadcast icon is dynamically changed to remind the user of the presence of currently live-broadcasted contents, without affecting the appearance of the live broadcast icon. By setting a dynamic reminding identification or a dynamic reminding instruction, the icons of other applications can be displayed in a distinguishing way, and thus the dynamic reminding function of the live broadcast icon can be displayed in a more highlighted way. The live broadcast icon is additionally provided with a dynamically displayed icon, so that the number of live broadcast reminding can be differentiated.

The flow of the method for dynamic reminding of live broadcast contents has been introduced in details above, the method can also be implemented through a corresponding device, and hereinafter, the structure and functions of the device will be introduced in details.

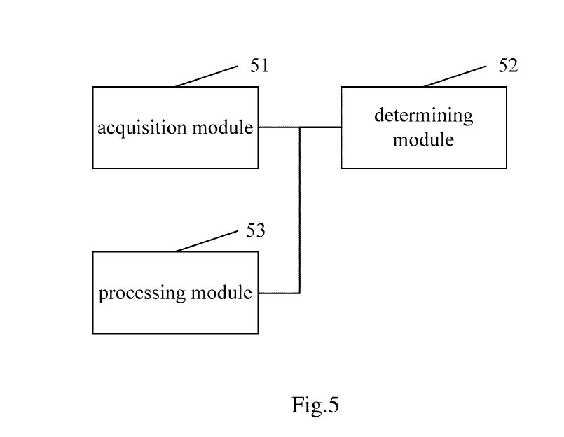

According to the embodiment of the present invention, an electronic device for dynamic reminding of live broadcast contents is provided. As shown in FIG. 5, the device includes:
an acquisition module 51, which is used for acquiring live broadcast appointment information submitted by a user, the live broadcast appointment information comprising live broadcast content information and/or appointment time information;
a determining module 52, which is used for determining an appointment time point according to the live broadcast appointment information, the appointment time point being a time point when the live broadcast content appointed by the user begins to play; and
a processing module 53, which is used for pushing, when the current time point reaches the appointment time point, a live broadcast message to the user, and switching a live broadcast icon from a stationary state to a dynamic reminding state.

In one embodiment, the dynamic reminding state of the live broadcast icon includes:
rotating the live broadcast icon or part of images in the live broadcast icon along a preset direction; and/or
periodically changing the color of the live broadcast icon or part of images in the live broadcast icon; and/or
periodically changing the transparency of the live broadcast icon or part of images in the live broadcast icon; and/or
periodically zooming the size of the live broadcast icon or part of images in the live broadcast icon.

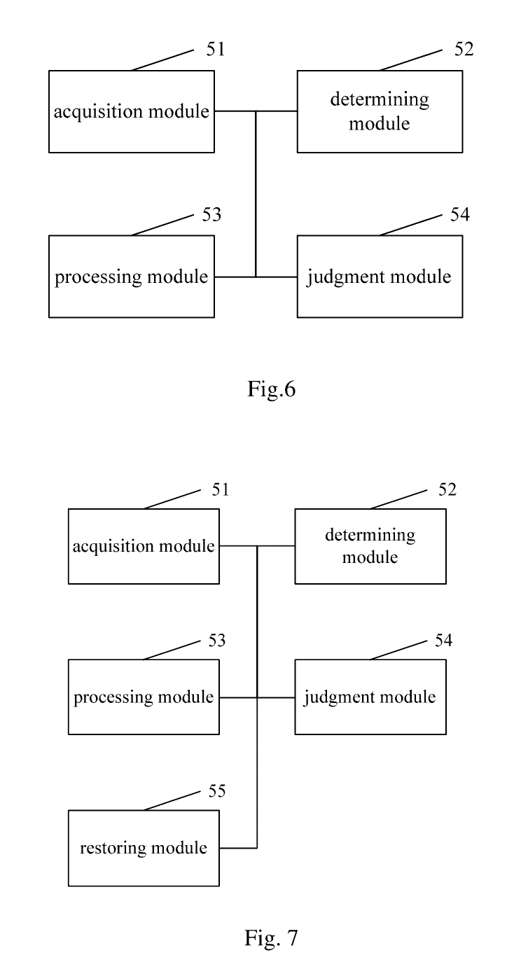

In one embodiment, as shown in FIG. 6, the device further includes a judgment module 54. When the current time point reaches the appointment time point, the judgment module is specifically used for:
judging whether the live broadcast icon has a dynamic reminding identification which is used for marking that the live broadcast icon has a dynamic reminding function; and when the live broadcast icon has the dynamic reminding identification, switching the live broadcast icon from a stationary state to a dynamic reminding state; or
judging whether the live broadcast appointment information contains a dynamic reminding instruction which is used for instructing the live broadcast icon to execute a dynamic reminding operation at the appointment time point; and when the live broadcast appointment information contains the dynamic reminding instruction, switching the live broadcast icon from a stationary state to a dynamic reminding state.

In one embodiment, as shown in FIG. 7, the device further includes a restoring module 55. After the live broadcast icon is switched from a stationary state to a dynamic reminding state, the restoring module is specifically used for switching, after receiving a live broadcast content playing instruction input by a user, the live broadcast icon to a stationary state.

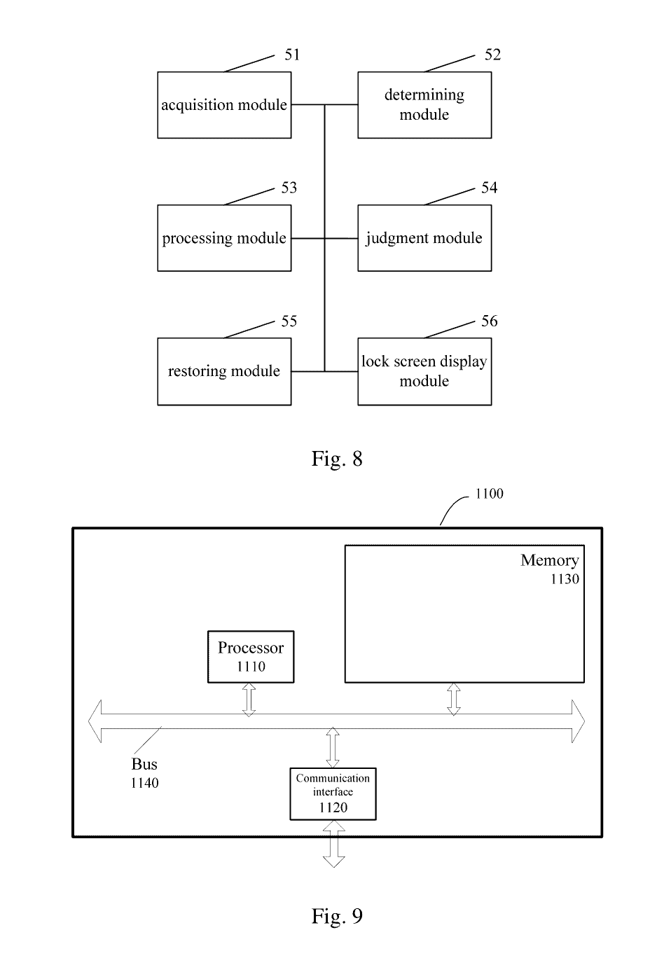

In one embodiment, as shown in FIG. 8, the device further includes a lock screen display module 56. After the live broadcast icon is switched from a stationary state to a dynamic reminding state, the lock screen display module is specifically used for dynamically displaying, when a mobile terminal is in a lock screen interface, the lock screen interface or part of images in the lock screen interface.

According to the method and electronic device for dynamic reminding of live broadcast contents provided in the embodiment of the present invention, an appointment time point is determined according to live broadcast appointment information submitted by a user, and a live broadcast icon is switched to a dynamic reminding state at the appointment time point. The method does not need to mark a red number in the right-upper corner of the icon, and the live broadcast icon is dynamically changed to remind the user of the presence of currently live-broadcasted contents, without affecting the appearance of the live broadcast icon. By setting a dynamic reminding identification or a dynamic reminding instruction, the icons of other applications can be displayed in a distinguishing way, and thus the dynamic reminding function of the live broadcast icon can be displayed in a more highlighted way. The live broadcast icon is additionally provided with a dynamically displayed icon, so that the number of live broadcast reminding can be differentiated.

### Embodiment 2

The embodiment of the present invention provides a non-transitory computer-readable storage medium storing executable instructions that, when executed by an electronic device, cause the electronic device to execute the processing method in the case of any method embodiment mentioned above.

### Embodiment 3

FIG. 9 illustrates a structure diagram of the electronic device for dynamic reminding of live broadcast contents in the embodiment of the present invention. The electronic device 1100 may be a host server, a personal computer (PC), or a portable computer or terminal and the like with computing power. The specific embodiments of the present invention do not limit concrete implementation of computing nodes.

The electronic device 1100 includes a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element includes, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present invention.

The memory 1130 is used for storing files. The memory 1130 may comprise a high-speed RAM memory, and may also comprise a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned program may be program codes comprising computer operating instructions. Specifically, the program can be used to execute the processing method in the case of any method embodiment mentioned above.

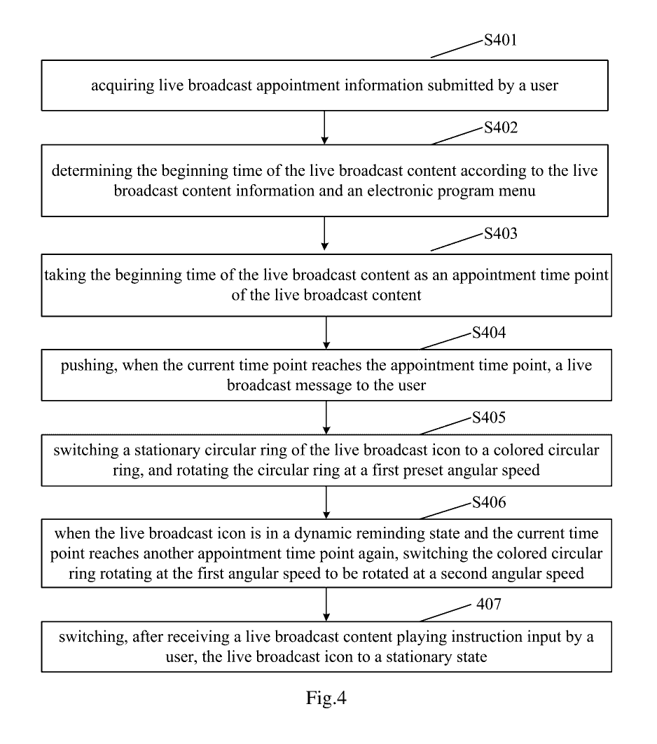

The present invention may have various embodiments in different forms. The technical solution of the present invention is illustrated above by taking FIG. 1 to FIG. 8 as examples in combination with the accompanying drawings, and this does not mean that the specific examples applied by the present invention can only be limited in specific flows or embodiment structures; and it shall be appreciated by those skilled in the art that the specific embodiments provided hereinabove are just some examples of a variety of preferred usages, and any embodiment embodying the claims of the present invention shall be within the protection scope claimed by the technical solution of the present invention.

Finally, it should be noted that only the preferred embodiments of the present invention are described above, and are not intended to limit the present invention. Although the present invention has been described in details with reference to the foregoing embodiments, those skilled in the part still can modify the technical solution stated in the various foregoing embodiments, or equivalently replace part of the technical characteristics therein. Any modification, equivalent replacement, improvement, etc. made within the spirit and principle of the present invention shall be included within the protection scope of the present invention.

What is claimed is:

1. A method for dynamic reminding of live broadcast contents, executed by an electronic device, the said method comprising:
acquiring live broadcast appointment information submitted by a user, the live broadcast appointment information comprising live broadcast content information and/or appointment time information;
determining an appointment time point according to the live broadcast appointment information, the appointment time point being a time point when the live broadcast content appointed by the user begins to play; and
pushing, when the current time point reaches the appointment time point, a live broadcast message to the user, and switching a live broadcast icon from a stationary state to a dynamic reminding state.

2. The method according to claim 1, wherein, the dynamic reminding state of the live broadcast icon comprises:
rotating the live broadcast icon or part of images in the live broadcast icon along a preset direction; and/or
periodically changing the color of the live broadcast icon or part of images in the live broadcast icon; and/or
periodically changing the transparency of the live broadcast icon or part of images in the live broadcast icon; and/or
periodically zooming the size of the live broadcast icon or part of images in the live broadcast icon.

3. The method according to claim 1, wherein, when the current time point reaches the appointment time point, further comprising:
judging whether the live broadcast icon has a dynamic reminding identification which is used for marking that the live broadcast icon has a dynamic reminding function; and when the live broadcast icon has the dynamic reminding identification, switching the live broadcast icon from a stationary state to a dynamic reminding state; or
judging whether the live broadcast appointment information contains a dynamic reminding instruction which is used for instructing the live broadcast icon to execute a dynamic reminding operation at the appointment time point; and when the live broadcast appointment information contains the dynamic reminding instruction, switching the live broadcast icon from a stationary state to a dynamic reminding state.

4. The method according to claim 1, wherein, after the live broadcast icon is switched from a stationary state to a dynamic reminding state, further comprising:
after receiving a live broadcast content playing instruction input by a user, switching the live broadcast icon to a stationary state.

5. The method according to claim 1, wherein, after the live broadcast icon is switched from a stationary state to a dynamic reminding state, further comprising:
when a mobile terminal is in a lock screen interface, dynamically displaying the lock screen interface or part of images in the lock screen interface.

6. An electronic device, comprising:
at least one processor; and
a memory communicably connected with the at least one processor for storing instructions executable by the at least one processor, wherein execution of the instructions by the at least one processor causes the at least one processor to:
acquiring live broadcast appointment information submitted by a user, the live broadcast appointment information comprising live broadcast content information and/or appointment time information;
determining an appointment time point according to the live broadcast appointment information, the appointment time point being a time point when the live broadcast content appointed by the user begins to play; and
pushing, when the current time point reaches the appointment time point, a live broadcast message to the user, and switching a live broadcast icon from a stationary state to a dynamic reminding state.

7. The electronic device according to claim 6, wherein execution of the instructions by the at least one processor causes the at least one processor to:
rotating the live broadcast icon or part of images in the live broadcast icon along a preset direction; and/or
periodically changing the color of the live broadcast icon or part of images in the live broadcast icon; and/or
periodically changing the transparency of the live broadcast icon or part of images in the live broadcast icon; and/or
periodically zooming the size of the live broadcast icon or part of images in the live broadcast icon.

8. The electronic device according to claim 6, wherein execution of the instructions by the at least one processor causes the at least one processor to:
when the current time point reaches the appointment time point, judging whether the live broadcast icon has a dynamic reminding identification which is used for marking that the live broadcast icon has a dynamic reminding function; and when the live broadcast icon has the dynamic reminding identification, switching the live broadcast icon from a stationary state to a dynamic reminding state; or
judging whether the live broadcast appointment information contains a dynamic reminding instruction which is used for instructing the live broadcast icon to execute a dynamic reminding operation at the appointment time point; and when the live broadcast appointment information contains the dynamic reminding instruction, switching the live broadcast icon from a stationary state to a dynamic reminding state.

9. The electronic device according to claim 6, wherein execution of the instructions by the at least one processor causes the at least one processor to:
after the live broadcast icon is switched from a stationary state to a dynamic reminding state, and after receiving a live broadcast content playing instruction input by a user, switching the live broadcast icon to a stationary state.

10. The electronic device according to claim 6, wherein execution of the instructions by the at least one processor causes the at least one processor to:
after the live broadcast icon is switched from a stationary state to a dynamic reminding state, and when a mobile terminal is in a lock screen interface, dynamically displaying the lock screen interface or part of images in the lock screen interface.

11. A non-transitory computer-readable storage medium storing executable instructions that, when executed by an electronic device, cause the electronic device to:
acquiring live broadcast appointment information submitted by a user, the live broadcast appointment information comprising live broadcast content information and/or appointment time information;
determining an appointment time point according to the live broadcast appointment information, the appointment time point being a time point when the live broadcast content appointed by the user begins to play; and
pushing, when the current time point reaches the appointment time point, a live broadcast message to the user, and switching a live broadcast icon from a stationary state to a dynamic reminding state.

12. The non-transitory computer-readable storage medium according to claim 11, the said instructions is used for causing the electronic device to:
rotating the live broadcast icon or part of images in the live broadcast icon along a preset direction; and/or
periodically changing the color of the live broadcast icon or part of images in the live broadcast icon; and/or
periodically changing the transparency of the live broadcast icon or part of images in the live broadcast icon; and/or
periodically zooming the size of the live broadcast icon or part of images in the live broadcast icon.

13. The non-transitory computer-readable storage medium according to claim 11 wherein the said instructions is used for causing the electronic device to:
when the current time point reaches the appointment time point, judging whether the live broadcast icon has a dynamic reminding identification which is used for marking that the live broadcast icon has a dynamic reminding function; and when the live broadcast icon has the dynamic reminding identification, switching the live broadcast icon from a stationary state to a dynamic reminding state; or
judging whether the live broadcast appointment information contains a dynamic reminding instruction which is used for instructing the live broadcast icon to execute a dynamic reminding operation at the appointment time point; and when the live broadcast appointment information contains the dynamic reminding instruction, switching the live broadcast icon from a stationary state to a dynamic reminding state.

14. The non-transitory computer-readable storage medium according to claim 11, wherein the said instructions is used for causing the electronic device to:
after the live broadcast icon is switched from a stationary state to a dynamic reminding state, and after receiving a live broadcast content playing instruction input by a user, switching the live broadcast icon to a stationary state.

15. The non-transitory computer-readable storage medium according to claim 11, wherein the said instructions is used for causing the electronic device to:
after the live broadcast icon is switched from a stationary state to a dynamic reminding state, and when a mobile terminal is in a lock screen interface, dynamically displaying the lock screen interface or part of images in the lock screen interface.
